(19) United States
(12) Patent Application Publication
(10) Pub. No.: US 2005/0274760 A1
(43) Pub. Date: Dec. 15, 2005

(54) Spare tire carrier

(75) Inventors: Thomas G. Buckner, Gibsonia, PA (US); James M. Helms, Fort Myers, FL (US); J. Stephen Sarles, Adams Township, PA (US)

Correspondence Address: FERENCE & ASSOCIATES, 409 BROAD STREET, PITTSBURGH, PA, 15143, US

(73) Assignee: Ibis Tek., LLC, Butler, PA (US)

(21) Appl. No.: 10/853,904

(22) Filed: May 25, 2004

(51) Int. Cl. B60R 9/00; B60R 11/00

(52) U.S. Cl. 224/503; 224/509

(57) ABSTRACT

A rear mounted spare tire carrier which is suitable for very heavy tires and which may be used in demanding environments, such as environments encountered by off road vehicles and military vehicles, is disclosed.

### FIELD OF THE INVENTION

The present invention relates generally to spare tire carriers, and more particularly to rear mounted spare tire carriers suitable for very heavy tires and which may be used in demanding environments, such as environments encountered by off road vehicles and military vehicles.

### BACKGROUND OF THE INVENTION

For a variety of reasons, it is often desirable for a vehicle to be equipped with a spare tire. Indeed, the desirabilty and necessity of carrying a spare tire is well established. Spare tires are generally stowed in designated locations with regard to the specific type of vehicle. The spare tire in an automobile, for example, is conveniently located within the trunk or cargo compartment. In light trucks and derivative recreational and off-road vehicles, the spare tire is typically supported against the underside of the vehicle or the rear of the vehicle. Various placements of a spare tire are employed for motor homes and travel trailers.

Under-chassis placement on vehicles that are used for off road or cross-country travel, including military vehicles, is particularly problematic. The depending assemblage of tire and mount present an encumbrance that is readily snagged or caught upon brush, rocks, and other terrain obstacles, impeding progress and incurring damage to the vehicle. Interior storage space, on the other hand, is generally inconvenient and wasteful of precious cargo space.

Spare tire carriers for such vehicles have traditionally been mounted at the rear of the vehicle. A concern with such positioning, however, is that if the vehicle is equipped with a tailgate or some other type of rear closure assembly such as a door, a rear mounted tire carrier should not interfere with the operation of the closure assembly. To address this concern, many conventional spare tire carriers have been mounted on a pivotable frame to allow the carrier to be swung away from the rear closure assembly.

A relatively simple yet well known unit incorporates a pair of angularly disposed arms. The free end of each arm is hingedly affixed to the body of the vehicle. An arrangement for detachably securing a spare tire is typically carried at the apex of the arms. Rotation of the device, between stowed or normal position and the door access position, is about a vertical axis. This configuration, however, has proven to be less than satisfactory. A primary deficiency is associated with the mounting upon the body. Vehicular body panels are commonly fabricated of relatively lightweight material. The combined mass of the carrier and the tire, constantly vibrating when the vehicle is underway, imparts stress and fatigue to the body panel resulting in eventual material failure. Other devices have been mounted on the a combination of the vehicle body and rear vehicle bumper, or mounted on a rear vehicle bumper.

In addition to not interfering with the tailgate or some other type of rear closure assembly, a problem to be overcome with spare tire carriers mounted on the rear of a vehicle is the need to lift the tire off of the carrier or to lift the tire onto the tire carrier. This is a particular difficulty with tires for off road and military vehicles, which tend to be significantly larger and four to five times heavier than tires for commercial vehicles. Furthermore, spare tire carriers designed for on road use have not been able to withstand the stresses and strains placed upon them when supporting a larger tire in an off road environment, including those encountered by military vehicles.

By way of example, one such military vehicle where this is of particular concern is the High Mobility Multipurpose Wheeled Vehicle (HMMWV or HumVee) manufactured by AM General. There are currently two commercial versions of the HumVee; the Hummer 1 is manufactured by AM General and the Hummer 2 is manufactured by General Motors. By way of comparison, a tire for a passenger car typically measures approximately twenty seven (27) inches in diameter and has a tread width of approximately seven (7) inches. A tire for a HumVee, however, measures thirty seven (37) inches in diameter and has a tread width of twelve (12) inches. The HumVee provides at least sixteen (16) inches of ground clearance, and rides high off the ground. Indeed, spare tire carriers for the HumVee typically mount the spare tire approximately five (5) from the ground.

While there are a number of different HumVee models, a tire for a typical HumVee weighs approximately one hundred and twenty two (122) pounds and costs approximately US$800. HumVee tires may include a runflat system which permits the tire to be driven flat for twenty (20) miles at thirty miles per hour (30 mph) and a CTIS (Central Tire Inflation System) which allows the driver to inflate or deflate the tire on the move. Adjusting the tire pressure impacts the traction provided by the tire. Such options increase the weight and cost of a tire. The weight of these tires is of particular moment, given the US military's guidelines which recommend the per person lift load be no greater than forty two (42) pounds. Under these guidelines, a minimum of three (3) people are needed to lift a spare tire. Because of the cost of each tire, it is preferred that any damaged tires which are replaced in the field be recovered for repair. The weight of the tires, however, and the need to lift the tire to the spare tire carrier inhibits such recovery.

Because of the unsuitability of the commercial on road carriers which address the lifting of the tire to/from the carrier, the disclosures of these references have not been implemented for off road vehicles, including military vehicles such as the HumVee. There have been attempts to address the needs of a spare tire carrier in an off road environment.

U.S. Pat. No. 6,659,318, issued to Anthony Newbill, on Dec. 9, 2003, discloses a bumper mounted spare tire carrier suitable for use on a sports utility vehicle. While a sports utility vehicle was generally conceived as an off road vehicle, such a vehicle is often used in an on road environment. The Newbill device appears to be directed for use in an on road environment as it is not designed to function in demanding off road conditions. By way of example, the Newbill device includes a support arm 12 which, while supporting a spare tire, also functions as a lever arm. As such, the tire would have an unacceptable amount of sway in a demanding off road environment, such as that HumVees are required to perform in. For example, a HumVee is capable of scaling an eighteen (18) inch vertical wall, with approach and departure angles of seventy two degrees (72°) and thirty seven and one half degrees (37.5°).

U.S. Pat. No. 6,631,834, issued to Paul Slovik on Oct. 14, 2003, discloses a spare tire carrier suitable for use on an off road vehicle, and a HumVee in particular. The Slovick device includes tire support 150, which also functions as a lever arm, but to a much lesser degree than the device of Newbill. Furthermore, while capable of being mounted to a vehicle lacking a bumper, the preferred embodiment of Slovick is bumper mounted. When the device of Slovick is mounted to a vehicle without a bumper, such as a HumVee, issues arise regarding the ready accessibility of other devices mounted to the frame of the vehicle, i.e., accessibility to tow hooks, lifting rings, etc.

In view of the foregoing, several needs have been recognized, among which is a need to provide a spare tire carrier capable of supporting the heavy tires used on off road vehicles, including military vehicles, in which lifting of the tire is minimized, and which is capable of handling the stresses and strains associated with operating in an extremely rugged environment.

### SUMMARY OF THE INVENTION

In accordance with a preferred embodiment of the invention that will be illustrated herein, the problem of carrying a spare tire on a vehicle is addressed. The present invention permits a spare tire to be carried on the rear of a vehicle while not interfering with the functionality of the rear closure of the vehicle and other components situated at the rear of the vehicle, such as a trailer hitch.

The present invention provides an apparatus for carrying a vehicle spare tire, said apparatus comprising: a first mounting plate for attachment to a vehicle; a frame pivotably connected to said first mounting plate; an arm pivotably connected to said frame and having a wheel engageable member near its distal end, wherein the arm is adapted to be operatively secured to said frame at a second point such that upon being secured the arm functions as part of said frame; a device which provides a mechanical advantage in pivoting the arm pivotably connected to said frame; and a second mounting plate for attachment to a vehicle adapted to secure the frame.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1 shows an embodiment of a spare tire carrier in accordance with the present invention on a vehicle with a tire.

FIG. 2 shows an embodiment of the spare tire carrier in accordance with the present invention in an open position.

FIG. 3 shows a portion of an embodiment of the spare tire carrier in accordance with the present invention when the spare tire carrier is in the open position.

FIG. 4 shows an embodiment of a mounting bracket for the spare tire carrier in accordance with the present invention

FIG. 5 shows an alternative embodiment of the spare tire carrier in accordance with the present invention.

FIG. 6 shows an embodiment of a system used to raise or lower a spare tire in accordance with the present invention.

FIGS. 7(a) and 7(b) show further alternative embodiments of the spare tire carrier in accordance with the present invention.

### DESCRIPTION OF THE PREFERRED EMBODIMENTS

At least one embodiment of the present invention broadly contemplates a rear mounted spare tire carrier. While the present invention is suitable for heavy tires, it should be understood the invention may also be used with lighter tires. Also, while the present invention is suitable for use in an off-road environment, it should be understood the present invention may also be used in less demanding environments. Though embodiments of the present invention will now be described with reference to a particular military vehicle (HumVee), it should be understood the invention is not limited to use on this particular vehicle and the invention may be used on any vehicle, military or civilian, car or truck, where the need arises for the present invention.

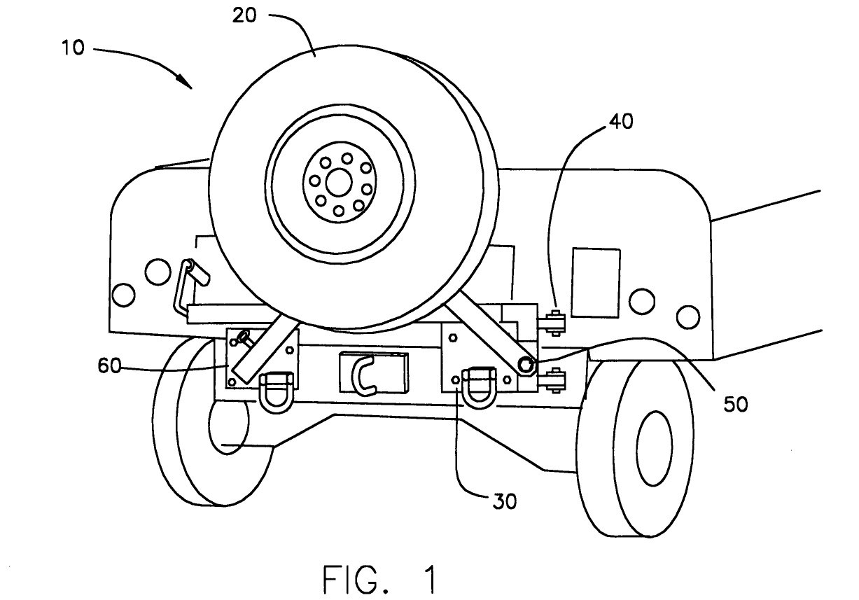

Referring now to FIG. 1, a spare tire carrier 10 in accordance with the present invention is shown in the closed or secured position. Reference numeral 20 denotes the spare tire. Reference numeral 30 denotes a first mounting bracket, which is configured to permit pivoting about point 40 and swinging about point 50. Reference numeral 60 denotes a second mounting bracket which is configured to secure the present invention to prevent pivoting about point 50. As shown in FIG. 1, and as will be described in more detail hereinbelow, mounting brackets 30, 60 are attached to frame members of the vehicle, in particular the vehicle I-beams. It should be noted that mounting brackets 30, 60 could alternatively be attached to a vehicle bumper (not shown), either using pre-existing mounting holes, custom mounting holes, or otherwise.

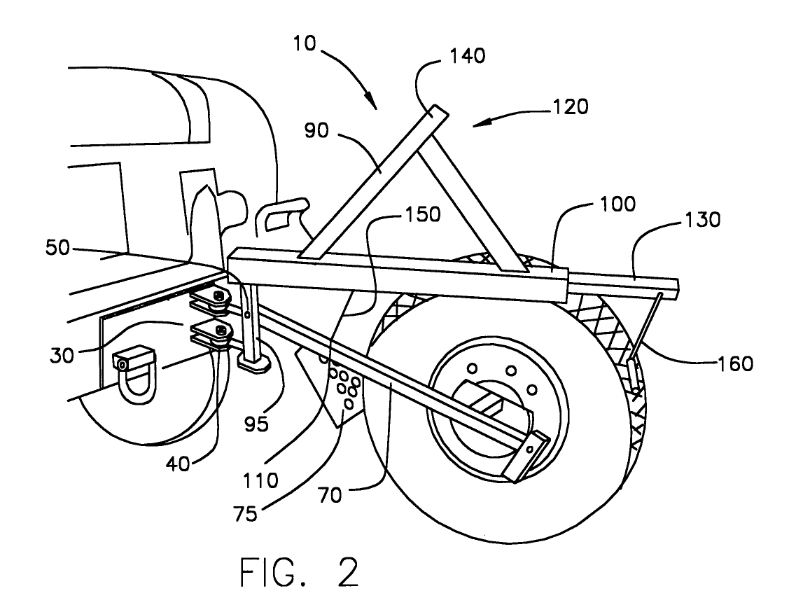

Referring now to FIG. 2, it can be seen that spare tire carrier 10 generally comprises a frame consisting of a generally A frame shaped member denoted by reference numeral 90, which is attached to generally horizontal member 100, which in turn is attached to generally vertical member 95; pivoting member 70; and mounting brackets 30, 60. The material and manner of attachment may be made by any manner appropriate to the environment in which the spare tire carrier will be operated, so long as the material and manner is sufficient to withstand the stresses and strains placed upon the spare tire carrier. The presently preferred material is 2″×2″ square steel, having a thickness of 0.187 inches; the presently preferred manner of attachment is welding. Is should also be noted that various angles may optionally be braced. One such angle which may be braced is the connection of generally horizontal member 100 and generally vertical member 95.

Spare tire carrier 10 is shown in the open position, swung away from the vehicle to permit access to the back of the vehicle, with the tire in the down (or ground) position. Thus, at mounting bracket 30, the device is swung about point 40 and pivoted about point 50 on vertical member 95. The apex is generally denoted by reference numeral 120, and includes a slight protrusion 140. Reference numeral 70 denotes the member to which tire 20 is attached and which pivots about point 50. As shown, member 100 and member 130 house a system, together with handle 140, is used to raise or lower tire 20. Handle 160 is operative connected to the member 70 at point 110 on brace 70 through a cable 150 or the like.

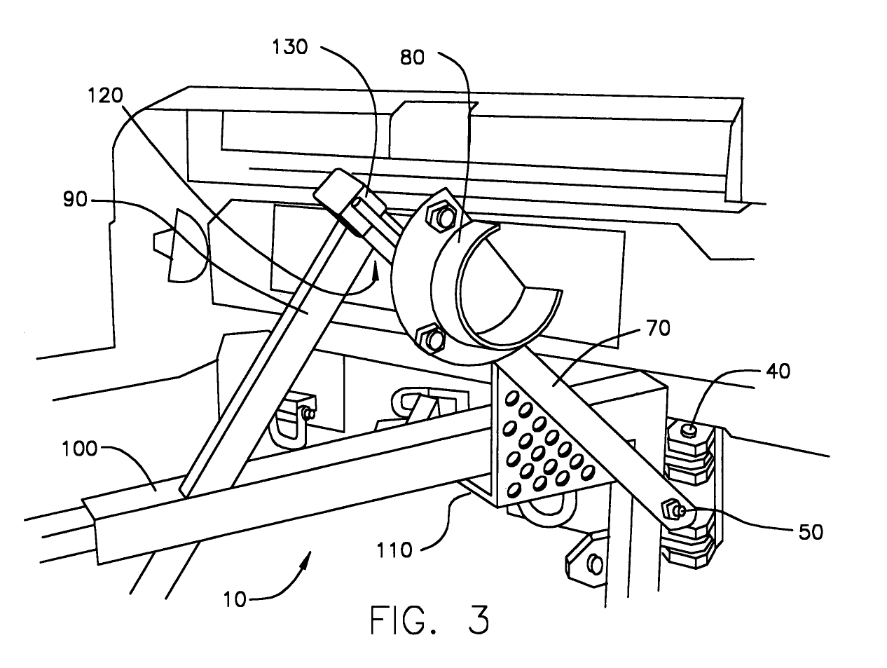

Referring now to FIG. 3, spare tire carrier 10 is again shown in the open position, swung away from the vehicle to permit access to the back of the vehicle, with the portion of the device to which the tire would be connected in the up (or elevated) position. At apex 120 of generally A framed member 90, pivot member 70 is preferably co-extensive with protrusion 140, and protrusion 140 and member 170 are preferably secured together by connector 130. As shown, connector 130 is in the nature of a band which fits over the circumference of protrusion 140 and pivot member 70. Preferably, there is a stop on protrusion 140 on which the connector 130 rests. Optionally, there may be a further connector (such as an engagement rod) to assist in preventing connector 30 from disengaging.

While spare tire 20 is not shown, reference numeral 80 denotes the point of attachment of the spare tire. Point of attachment 80 is located near the end of pivot member 70 opposite from the pivot point and preferably extends from pivot member 70 a sufficient distance such that the back of tire 20 is flush with pivot member 70. Optionally, there may be some form of a right angle brace to additionally support attachment point 80. Point of attachment 80 includes lugs 81 and tire spinner 82. Although any appropriate lug may be used, it is presently preferred the lugs match those on the wheels of the vehicle to which the spare tire carrier of the present invention will be mounted. Tire 20 is attached to lugs 81 using lug nuts (not shown), and if the lugs are the same as those on the vehicle wheels, the tire carrier provides extra lug nuts should one of the wheel lug nuts become unavailable. Furthermore, three lugs 81 are shown, and are presently preferred, although it should be understood that any number of lugs may be provided. Providing three lugs merely provides two extra lug nuts, as one lug and nut are sufficient to secure tire 20 to point of attachment 80.

Tire spinner 82 is particularly useful in mounting tire 20 to point of attachment 80, as it permits tire 20 to be supported while the rim of tire 20 is aligned with lug nuts 81. In particular, tire spinner 82 extends out from point of attachment 80 past the length of lugs 81. This permits tire spinner 82 to support the weight of tire 20 while the lug holes in the rim of tire 20 are aligned with lugs 81. Indeed, during preferred operation, pivot member 70 is positioned such that a tire may be leaned up against point of attachment 80 such that tire spinner 82 is protruding through the interior opening in the rim of tire 20. Pivot member 70 is then positioned such that tire 20 is off the ground. At that point in time, tire 20 is spun around tire spinner 82 until the lug holes in the rim align with lugs 81. Tire 20 is then pushed back and lug nuts are applied to lugs 81 to secure tire 20 to point of attachment 80. The problem of having to lift the tire to align the lug holes in the rim with the lug nuts is eliminated. As shown, tire spinner 82 is circular in nature and is a solid circle. This is a design choice; less material may be used such that tire spinner 82 is not a complete circle. The important consideration is for tire spinner 82 to extend far enough around in circumference to meaningfully connect with the interior opening in the rim of tire 20 when pivot member 70 is in the lowered position. Indeed, there is no reason why tire spinner 82 could not have an unbroken circumference.

Tire spinner 82 may be optionally perforated in a manner to permit a padlock or the like to be placed through tire spinner 82 at a particular point. When this is done, unauthorized removal of tire 20 from spare tire carrier 10 becomes much more difficult, as it is more involved than merely removing the lug nuts securing tire 20 to attachment point 80.

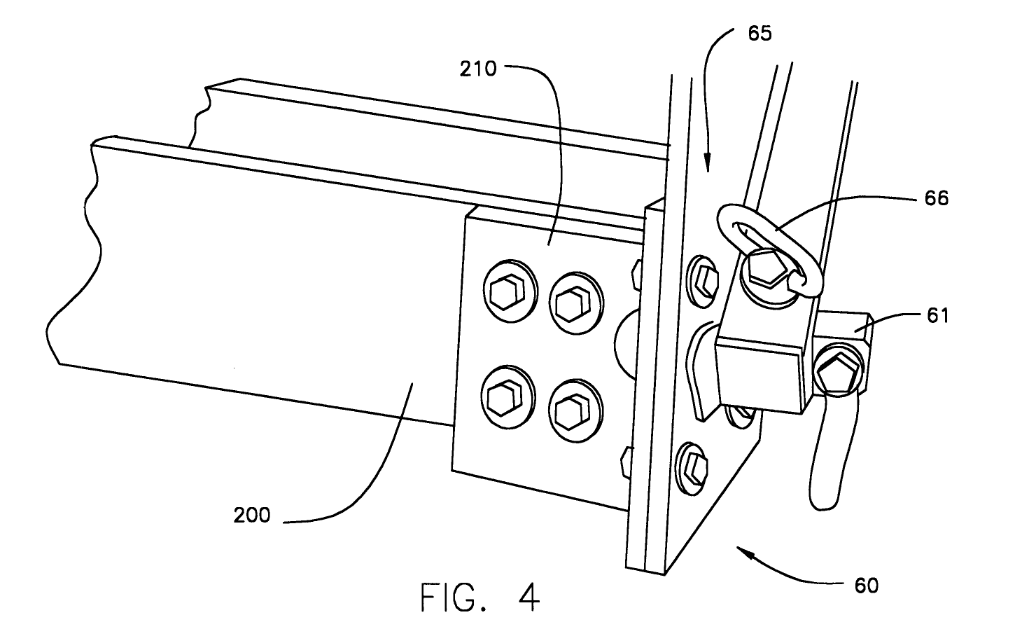

Referring now to FIG. 4, mounting bracket 60 is shown in detail. As shown, mounting bracket 60 includes portion 210 which is fixedly attached to I-beam 200 and portion 65, which is fixedly attached to portion 210. Portion 65 also includes a receptacle for the lower portion of one end of generally A framed member 90, which is shown being secured by pin 66, and a mounting point 61 for a clevis.

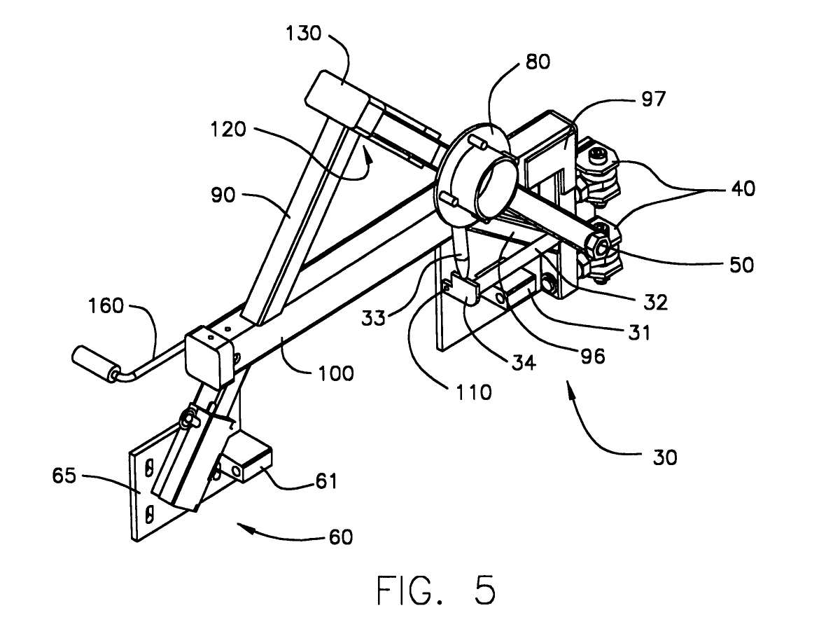

Referring now to FIG. 5, another embodiment of the present invention is shown. While like reference numerals are used to refer to like parts, changes from the prior embodiment will now be discussed. Portion 65 of mounting plate 60 includes a hinged portion which now covers the lower portion of generally A shaped member 90, and which accepts one pin to secure the lower portion of generally A shaped member 90. Additional pins may be used if preferred. This is presently preferred, as it has been found that such an arrangement provides greater attachment security. Handle 140 is now operatively connected to a system contained exclusively within member 100, which is presently preferred as it is more compact. In this preferred embodiment, connector 130 is in the nature of a cap. A pin may be optionally used to ensure connector 130 remains connected.

Attachment point 110 is contained with within a slightly different arrangement. In this embodiment, first mounting bracket 30 includes clevis attachment point 31. Pivot member 70 is braced with braces 32 and 33, and which converge at stop 34, which also contains attachment point 110. These braces may be of any suitable material, although, they are depicted as being tubular in nature. Furthermore, the connection of generally vertical member 95 and generally horizontal member 100 is braced by angle brace 96 and corner brace 97. It is presently preferred that angle brace 96 be of the same material as generally vertical member 95 and generally horizontal member 100, although any suitable material may be used. Similarly, it is presently preferred that corner brace 97 be 1″×1″ mild steel box channel, although any suitable material may be used. Of course, the type, materials, and amount of bracing may be varied depending on the load to be carried by the spare tire carrier and the stresses to be placed upon it.

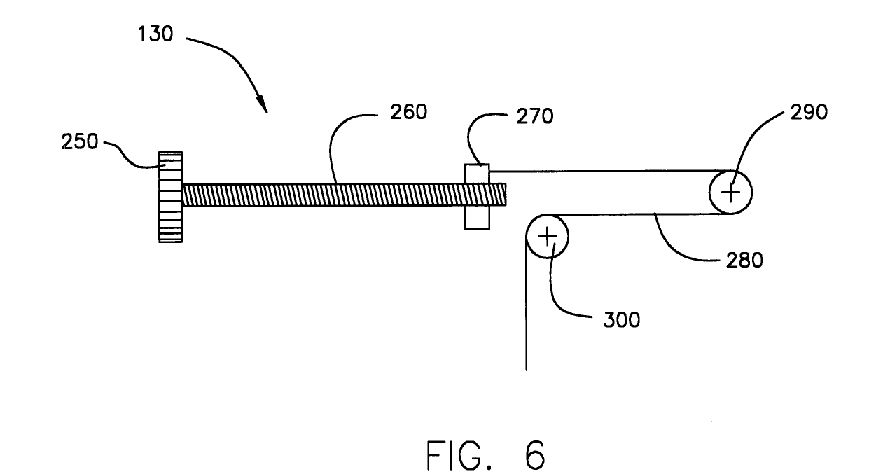

Referring now to FIG. 6, the system preferably used to raise or lower tire 20 is shown. Members 130 and/or 100 preferably contain a gear 250 for being operative connected to handle 140. Gear 250 is operatively connected to a piece of threaded material 260, which is operatively connected to bracket 270. It is presently preferred that the pitch rate of threaded material 260 is 10 threads per inch, although any suitable pitch rate may be used. As gear 250 is rotated, bracket 270 moves up and down threaded material 260. Connected to bracket 270 is material 280, which passes through pulley 290 and pulley 300 and is then connected to member 70 at the attachment point. It should be noted that material 280 may be steel cable, chain, roller chain, or any material capable of working within this system and withstanding the loads placed upon the material. It is presently preferred, however, that material 280 is stranded steel cable. Alternatively to the mechanical system shown, an electromechanical linear actuator may be used. A manufacturer of linear actuators which may be used is Thompson Saginaw. The selection of the linear actuator itself is essentially a design choice.

It should be noted that handle 140 has been shown as permanently attached to either member 130 or member 100. This need not be the case; handle 140 may be detachable. Further, any device sufficient to actuate gear 250 may be used, for example, a power drill. In this regard, gear 250 is only necessary if the attachment point is perpendicular to the direction of the threaded material. Accordingly, it may be desirous to attached a handle, attachment point, etc., parallel with the threaded material. Furthermore, to the extent that handle 10 is not permanently attached, it is desirable to use as a handle a handle that is capable of performing another function on the vehicle. An example would be utilizing the handle which is used for the vehicle jack.

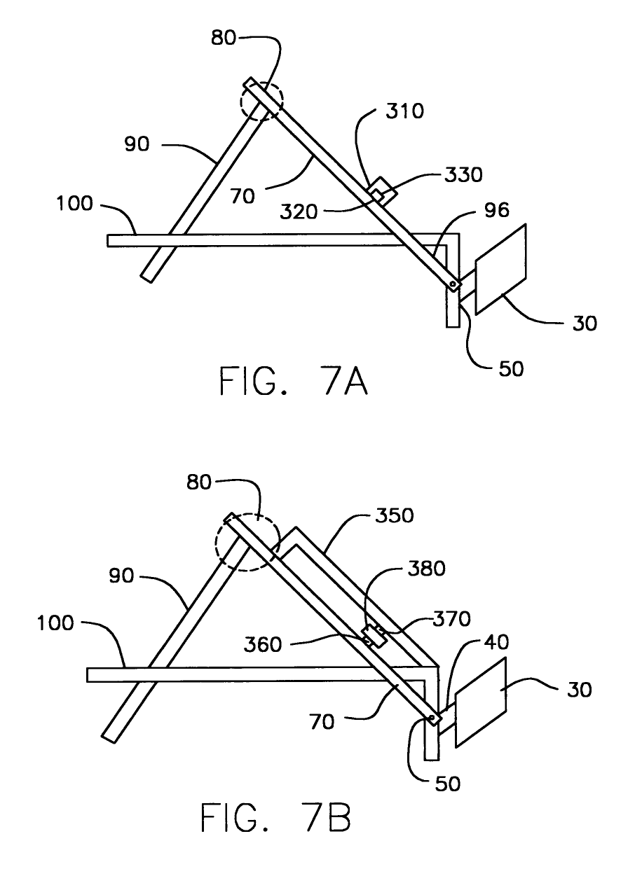

Referring now to FIGS. 7(a) an 7(b), alternative embodiments are shown. Again, like reference numerals are used to identify like components. In both of these embodiments, the manner in which in which pivot member 70 is raised and lowered varies; rather than being substantially contained within generally horizontal member 100, the mechanism by which pivot member 70 is raised or lowered is located on the frame of spare tire carrier 10. In FIG. 7(a), reference numeral 320 denotes the attachment point on pivot member 70, which is preferably a welded tab, although any suitable attachment point may be used. Reference numeral 320 denotes an attachment point on generally A frame shaped member 90 to which a mechanism for controlling pivot member 70 may be placed. Reference numeral 320 denotes the mechanism for controlling pivot member 70. In FIG. 7(b), reference numeral 350 denotes a member which is suitably attached, preferably by welding, to generally A frame shaped member 90 and generally horizontal member 100, and is substantially parallel to a portion of generally A frame shaped member 90. Reference numeral 360 denotes the attachment point on pivot member 70, which is preferably a welded tab, although any suitable attachment point may be used. Reference numeral 370 denotes an attachment point on member 380 to which a mechanism for controlling pivot member 70 may be placed. Reference numeral 380 denotes the mechanism for controlling pivot member 70.

The mechanism 330, 380 for controlling pivot member 70 may be any suitable mechanism. In one form, this mechanism includes threaded shafts with oppositely inclined threads engaged with an interiorly threaded sleeve. A ratchet drive for the sleeve may be used, and would preferably include a handgrip and a pawl manually settable to reversibly engage ratchet teeth for the extension and retraction of the threaded shafts. Alternatively, the mechanism 330, 380 for controlling pivot member 70 may be a hydraulic cylinder, a winch (manual or electric), or a linear actuator.

While it is presently preferred that the spare tire carrier of the present invention be attached directly to the frame of a vehicle, it should be recognized the spare tire carrier of the present invention may also be attached to the bumper of a vehicle, either directly, or through the use of a bracket on the vehicle side of the bumper or frame. Such an installation renders the carrier detachable while avoiding modification of a vehicle bumper.

If not otherwise stated herein, it is to be assumed that all patents, patent applications, patent publications and other publications (including web-based publications) mentioned and cited herein are hereby fully incorporated by reference herein as if set forth in their entirety herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

1. An apparatus for carrying a vehicle spare tire, said apparatus comprising:
a first mounting plate for attachment to a vehicle;
a frame pivotably connected to said first mounting plate;
an arm pivotably connected to said frame and having a wheel engageable member near its distal end, wherein the arm is adapted to be operatively secured to said frame at a second point such that upon being secured the arm functions as part of said frame;
a device which provides a mechanical advantage in pivoting the arm pivotably connected to said frame; and
a second mounting plate for attachment to a vehicle adapted to secure the frame.

2. The apparatus of claim 1, wherein the wheel engageable member includes at least one lug for securing a wheel to the member and material extending past the lug which supports the wheel in a manner to permit the wheel to rotate and be aligned with the lug.

3. The apparatus of claim 2, wherein the material extending past the lug is capable of having a device coupled to the material thereby securing the wheel to the material.

4. The apparatus of claim 3, wherein the device is a padlock.

5. The apparatus of claim 1, wherein the device which provides a mechanical advantage comprises a threaded shaft.

6. The apparatus of claim 1, wherein the device which provides a mechanical advantage comprises a threaded shaft.

7. The apparatus of claim 6, wherein a handle is operative coupled to the threaded shaft.

8. The apparatus of claim 7, wherein the handle is a piece of equipment normally carried on the vehicle.

9. The apparatus of claim 7, wherein the handle is capable of being easily uncoupled from the threaded shaft.

10. The apparatus of claim 9, wherein the handle is a piece of equipment normally carried on the vehicle.

11. The apparatus of claim 6, wherein the threaded shaft is adapted to be operatively coupled to a power tool.

12. The apparatus of claim 11, wherein the power tool is a portable power tool.

13. The apparatus of claim 12, wherein the portable power tool is a battery operated drill.

14. The apparatus of claim 6, wherein the threaded shaft is operatively coupled to a motor.

15. The apparatus of claim 14, wherein the motor is an electric motor.

16. The apparatus of claim 14, wherein the motor is a hydraulic motor.

17. The apparatus of claim 1, wherein the device which provides a mechanical advantage comprises a hydraulic cylinder.

18. The apparatus of claim 1, wherein the device which provides a mechanical advantage comprises a gas cylinder.

19. The apparatus of claim 1, wherein the device which provides a mechanical advantage comprises a winch.

20. The apparatus of claim 19, wherein the winch is a mechanical winch.

21. The apparatus of claim 1, wherein the device which provides a mechanical advantage comprises an linear actuator.

22. The apparatus of claim 1, wherein the device which provides a mechanical advantage comprises an electric motor.
